(19) United States
(12) Patent Application Publication
(10) Pub. No.: US 2010/0193412 A1
(43) Pub. Date: Aug. 5, 2010

(54) Beam splitter

(75) Inventors: Larry H. Mack, JR., Sugar Land, TX (US); Gary Ernest Carver, Raritan Township, NJ (US)

Correspondence Address: CRAIN, CATON & JAMES, FIVE HOUSTON CENTER, 1401 MCKINNEY, 17TH FLOOR, HOUSTON, TX, 77010, US

(73) Assignees: Satake USA, Inc., Stafford, TX (US); Princeton Lightwave, Inc., Cranberry, NJ (US)

(21) Appl. No.: 12/364,218

(22) Filed: Feb. 2, 2009

(51) Int. Cl. B07C 5/342; G02B 27/10

(52) U.S. Cl. 209/585; 359/353

(57) ABSTRACT

A device for splitting light between the visible light spectrum and the near infrared light spectrum, particularly for separating reflected light between the visible light spectrum and the near infrared light spectrum, in determining multiple characteristics of product in a product scanning system. The invention also pertains to sorting machines that optically sort or separate nonstandard fungible objects from standard objects as they pass a viewing station by viewing such objects in at least two different wavelength spectrums and particularly to such sorting machines utilizing detector elements comprised of two or more different photo-sensitive devices and to the optical detection system used therein. The device includes a hermetically-sealed device with two transparent prisms between which is sandwiched indium tin oxide (ITO) selected to exhibit dielectric behavior in the VIS/NIR and metallic behavior in the NIR band.

### CROSS REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

1. Field of the Invention

The present invention relates to an apparatus for bifurcating a light beam between the visible light spectrum and the near infrared light spectrum, particularly for separating reflected light between the visible light spectrum and the near infrared light spectrum for determination of multiple characteristics of product in a product scanning system. This invention also pertains to sorting machines that optically sort or separate nonstandard fungible objects from standard objects as they pass a viewing station by viewing such objects in at least two different wavelength spectrums and particularly to such sorting machines utilizing detector elements comprised of two or more different photo-sensitive devices and to the optical detection system used therein.

2. Description of the Related Art

A typical sorting machine of the type with which the present invention is used is a high-speed sorting machine used for sorting small particles, including fungible particles in the food and pharmaceutical industries. However the invention may also be used in conveyor sorting machines or for examination of flowing solid materials.

For example, individual rice grains may be sorted in a gravity-fed sorter to separate grains selected as “substandard.” In the art, “substandard” may apply to a grain having any undesirable characteristic, including color, shape, size or breakage, or any other characteristic not within the limits for acceptable particles for a particular sorting. Alternative feed systems, such as belt driven conveyors, are also well-known in the art. Alternatively, certain rarer particles may be desirable and therefore deflected from the flow of the less rare and less desirable remaining particles.

Sorting machines may employ two or more optical sensors to differentiate based on color hues, size, moisture content or other characteristics as determined in radiation bands, which may be outside the visible color spectrum. When such sorting is accomplished by use of two radiation bands, the sorting procedure is referred to as bichromatic sorting.

Optical sorting machines of the type generally described above employ optical sensors that include multiple photodetectors, such as a charged-couple device and photodiode arrays. The photodetectors are positioned to observe the illuminated product stream through a light-penetrating window. The stream typically passes between an optical sensor and a background having a color shade that matches the product stream in standard color or shade so that only a variation in a product color or shade causes a detection event. The illumination is from one or more light sources directed at the product stream to cause standard reflectivity from standard products in the radiation bands being observed and to cause nonstandard reflectivity from nonstandard products in those bands.

Such sorting machines also include one or more ejector mechanisms located downstream of the sensor or sensors with multiple nozzles associated with one or more valves actuated by an electrical signal coordinated with sensor detection. When a particle having or lacking selected criteria is detected, an electrical signal is produced to actuate the valve of the ejector nozzle associated with the predicted location of the selected particle as the selected particle passes the ejector. The time elapsed between the selected particle passing the sensor or sensors and the selected particle being ejected is minimal to limit possible vertical and/or horizontal deflection of the selected particle upon contact with non-selected particles. Each ejector is therefore normally located as close as possible to the plane at which the optical sensor or sensors reviews the passing particles, typically referred to as the scan line, ideally being just downstream therefrom and closely adjacent thereto.

### SUMMARY OF THE INVENTION

It is therefore, a principle object of the present invention to provide a system which permits bichromatic sorting wherein the system splits light into two spectrums to separate cameras, specifically detector chips.

It is a further object of the present invention to provide that the two detector chips are not integrated with a lens.

It is a further object of the present invention to provide that the detector chips are not stacked atop each other but are rather adjacent.

It is a further object of the present invention to provide a beam splitter that divides the light reflected from product between visible light spectrum and the near-infrared light spectrum.

It is a farther object of the present invention to provide a beam splitter that does not require significant space within the sorting apparatus.

It is an advantage of the present invention to provide a beam splitter which separates visible light and the near-infrared light with minimal material and in minimal volume and which directs a first radiation band to a first photodetector while permitting the second radiation band to pass through the beam splitter to impinge on a second photodetector.

It is a further advantage to locate the photodetectors parallel to each other, and somewhat offset along the optic axis, such that both chips can be integrated within one hermetic package wherein the path length of the two bands in glass are approximately the same.

The foregoing objects and advantages are achieved through use of a beam splitter composed of indium tin oxide (ITO) selected to exhibit dielectric behavior in the VIS/NIR (ie high transmission & low reflection) and metallic behavior in the NIR band (ie low transmission & high reflection). Commercially-available ITO, typically used for ground planes in liquid crystal displays, exhibits high visible transmittance but does not exhibit high NIR reflectance. The ITO is then applied to a transparent material, preferably at a right angle to the plane on which the two photodetectors lie. The ITO coating splits the light beam into broad wavelength regions of the visible light spectrum and near-infrared spectrum by reflecting light in the near-infrared spectrum to a first photodetector, which may be via a mirror, while permitting light in the visible spectrum to pass through to a second photodetector. The first photodetector may be an indium gallium arsenide (InGaAs) photodiode array (PDA). The second photodetector may be a charge-coupled device (CCD). As a result of such beam splitter, the first and second photodetectors may be placed in parallel.

Uses of ITO have traditionally ranged from transparent heating elements of aircraft and car windows, antistatic coatings over electronic instrument display panels, heat reflecting mirrors, antireflection coatings and even in high temperature gas sensors. Early electro-optic devices using ITO include CCD arrays, liquid crystal displays and as transparent electrodes for various display devices. More recently, ITO has been used as a transparent contact in advanced optoelectronic devices such as solar cells, light emitting and photo diodes, phototransistors and lasers. Such uses of ITO have not, however, included separating light waves between the visible and near-infrared light spectrums to permit passage of light in the visible light spectrum while redirecting the light in the near-infrared light spectrum. Additionally ITO has never been used as a beam splitter for the purpose of separating light between visible light and near-infrared light for focusing on separate photodetectors. Finally ITO has never been used as a beam splitter for the purpose of separating light between two bands on separate photodetectors for sorting of product.

A key innovation of this structure is the ability to provide this reflected and transmitted performance with a single immersed layer. Typical thin films made of multiple dielectric layers exhibit erratic spectral oscillations at high angles of incidence when immersed between layers of glass.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only a typical preferred embodiment of the invention and are therefore not to be considered limiting of its scope as the invention may admit to other equally effective embodiments.

FIG. 1 is a front view of a sorter of the type with which the ejector manifold may be used.

FIG. 2 is a side view of a sorter of the type with which the ejector manifold may be used.

FIG. 3 is a cross-sectional side view of the optical system of the present invention.

FIG. 4 is a cross-sectional view of the beam splitting prism 29.

FIG. 5 is a graph of dielectric constants as a function of wavelength for three selected resistivities.

FIG. 6 is a graph of reflectance as a function of wavelength for three selected resistivities.

FIG. 7 is a graph of reflectance and transmission as a function of wavelength for two previously-selected resistivities and a third resistivity selected to divide the wavelength range.

### DETAILED DESCRIPTION OF THE PREFERRED EMBODIMENT

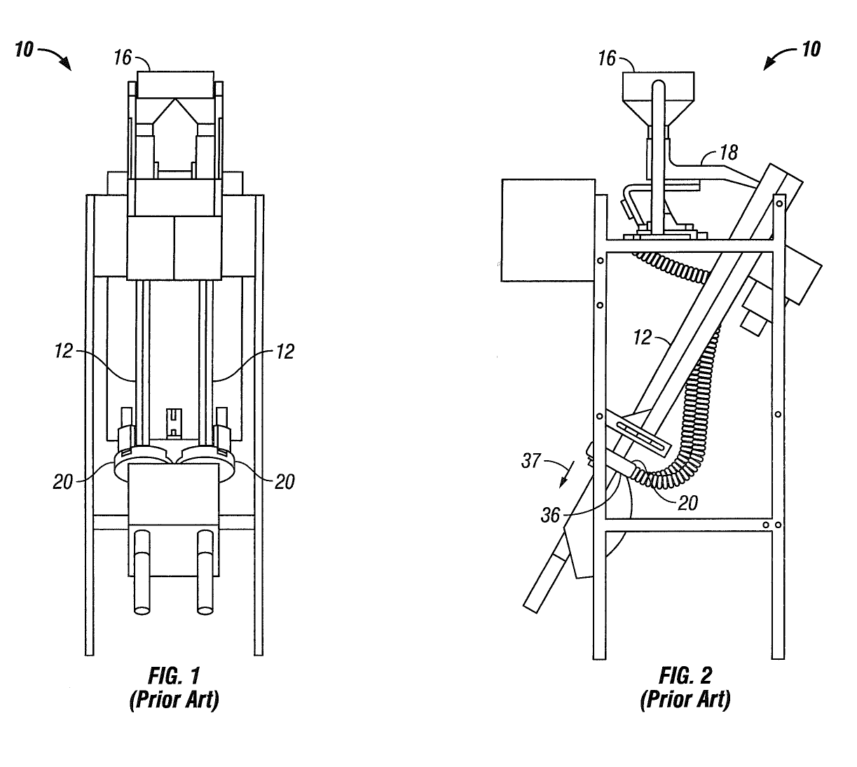

Referring to the FIGS. 1 and 2, a multi-channel, high-speed sorter for separating nonstandard particles from a passing stream or flow of such particles is shown. Generally, a typical sorting machine 10 includes one or more slides 12 at a steep angle, usually over 45 degrees from the horizon and preferably nearly vertical on the order of 80 degrees. A hopper 16 containing particles 17 to be sorted is attached to the same framework and provides gravity feed of the particles 17 by respective feeder 18 to the slides 12. The particles 17 to be separated or sorted are any small particle or particles, such as rice grains. Particle flow rate is less than free fall due to friction between a particle 17 and channel surface. As a result particle flow rate is quite high, as is well-known in the art. Machines having only a single channel and machines with many more than two channels are not uncommon. For separation or sorting, sorting machine 10 contains an optical sensor 20, to scan passing particles 17. The location at which the optical sensor 20 reviews the passing particles 17 is typically referred to as the scan line. When a particle 17 to be separated from the passing flow is identified from the output of an optical sensor 20, the corresponding nozzle of the ejector 36 is engaged, deflecting the nonstandard particle 15 from particle direction of travel 37.

Moreover the present invention may be used with any system whereby particles 17 are moved along a chute or belt.

An optical sensor 20, described more fully below, is located toward the bottom of the slide 12. As particles 17 pass the optical sensor 20, any nonstandard particles are sensed or detected. It will be appreciated that such sensing or detection requires the nonstandard products to be distinguished from the standard particles and from any background. Typically, a nonstandard particle, such as substandard cereal grain, is detectable on the basis of being darker or lighter or of a different color or hue from an acceptable range of darkness, lightness, or color predetermined for standard or acceptable items. This identification is accomplished simultaneously within two separated spectral ranges. When the nonstandard particle is identified, an electrical signal is produced that results in a deflection of the nonstandard particle sensed from the stream of particles 17.

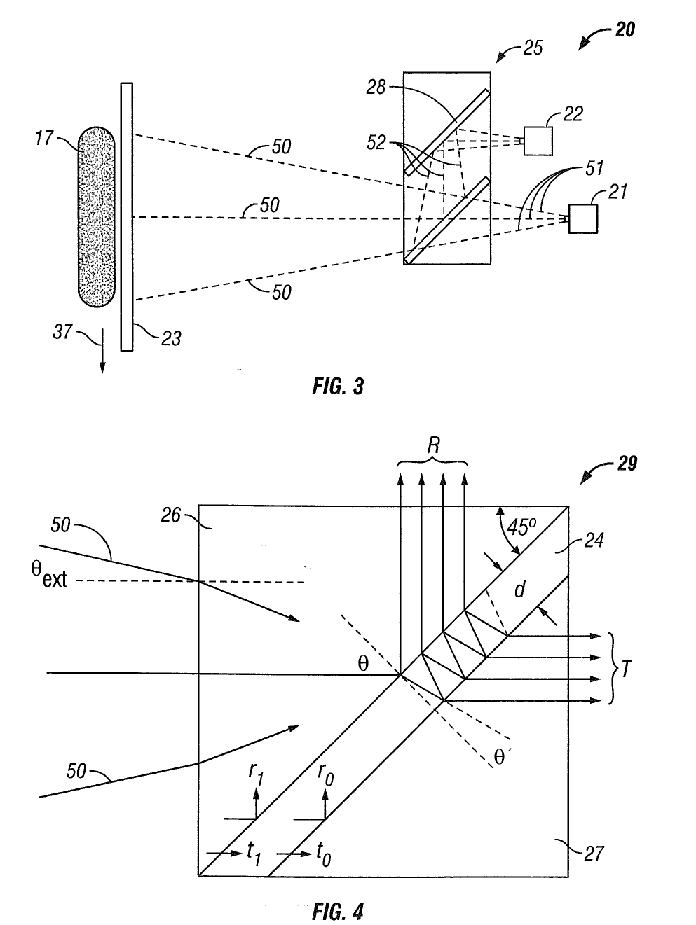

Referring to FIG. 3, the optical sensor 20 is illustrated as seen from the side. The optical sensor 20 includes a lens 23 proximate the stream of particles 17. The stream of particles 17 is in the object plane of the lens 23. A light source (not shown) illuminates the particles 17 before the lens 23, such that light 50 is reflected from a particle 17 through the lens 23 and thereby impinges on the beam splitter 25 and is focused to impinge on a photodetector 21. The beam splitter 25 permits light 51 within the visible/near infrared (VIS/NIR) light spectrum band, typically in the range of 400 to 900 nm, to pass through to impinge on the photodetector 21 while reflecting light 52 within the near-infrared spectrum band, typically in the range of 1200 to 1700 nm, to focus and impinge on the photodetector 22, which may be by reflection from a reflector 28. In the preferred embodiment a charge-coupled device (CCD) is used for the visible light spectrum while a photodiode array (PDA) using indium gallium arsenide (InGaAs) is used for the NIR spectrum. A window or viewer (not shown) may be located between the lens 23 and the particle 17.

As depicted in FIG. 4, the beam splitter 25 includes wavelength-selective material 24, which is established at 45 degrees with respect to the axial paths of the reflected light 50 as transmitted by the lens 23. The wavelength-selective material 24 is affixed between a first transparent triangular prism 26 and a second transparent triangular prism 27. It is imperative that images processed by the photodetector 21 and the photodetector 22 are spatially co-registered across the field of view. This co-registration can only occur if the optical path length of the two light bands through the first transparent triangular prism 26 and the second transparent triangular prism 27 are the same. An optical path length is the physical distance traveled multiplied by the index of refraction of the material traveled through. The first transparent triangular prism 26 and the second transparent triangular prism 27 may be of any optically-transmissive material, but in the preferred embodiment are composed of glass. This path length restriction dictates that the wavelength-selective coating be affixed between the first transparent triangular prism 26 and the second transparent triangular prism 27. Standard thin film dielectric stacks cannot provide high selectivity between the two bands over a large field of view unless the films are positioned between glass and air. This difficulty is overcome by using a layer of indium tin oxide (ITO) as the wavelength-selective material 24 between the first transparent triangular prism 26 and the second transparent triangular prism 27. The wavelength-selective material 24 may be affixed using index-matching epoxy. In the preferred embodiment, the wavelength-selective material 24 is deposited on one triangular prism and adhered to the other triangular prism with epoxy. Alternatively, the wavelength-selective material 24 may be deposited on a flat substrate and the substrate adhered to the one or both triangular prisms with epoxy.

ITO coatings are typically identified with two numbers—resistance in ohms per square and thickness. These two numbers actually specify the resistivity, ρ, since ρ=Res*d, where Res is the materials resistance and d is the material distance. Resistivity is the inverse of conductivity, and is the material property of interest in specifying a specific ITO film. By selecting the proper resistivity, the ITO layer exhibits the necessary dielectric behavior in the 400-900 nm band, i.e. high transmittance, T, of incident light and metallic behavior in the 1200-1700 nm band, i.e. high reflectance, R of incident light. In the preferred embodiment the dielectric behavior provides transmittance of at least 60% of impinging light in the 400-900 nm band, while the metallic behavior provides reflectance of at least 50% of impinging light in the 1200-1700 nm band. Based on such resistivity, ITO thickness and corresponding resistance may be determined. It has been determined that an immersed ITO with a resistivity of approximately 155 μΩcm, as a compromise between high visible transmittance (for the CCD detector array) and high infrared reflectance (for the PDA detector array), provides the beam-splitting properties sought. The desired range of resistivity should not be below 150 μΩcm and should not be above 160 μΩcm. Resistivity below 129 μΩcm or above 165 μΩcm produces unacceptable results.

Typical thin films made of multiple dielectric layers exhibit erratic spectral oscillations at high angles of incidence when immersed between layers of glass. Modeling the optical properties of ITO permits identification of the proper resistivity of a single dielectric layer so such undesirable spectral oscillations may be avoided. The optical properties of ITO can be modeled with the Drude free electron model if the relaxation time is frequency dependent. The Drude formulism expresses the dielectric function, ε(ω), in terms of three quantities:

ε(ω)=ε_{∞}−ωₚ²(1/(ω²+iω/τ)),

where ε_{∞} is the high frequency dielectric constant, ωₚ is the plasma frequency, and τ is the relaxation (or electronic scattering) time. The plasma frequency can be further expressed as ωₚ²=ne²/mεₒ (where n is carrier concentration, e is electronic charge, m is effective mass, and εₒ is the capacivity of free space). Since resistivity=ρ=m/ne²τ, a higher carrier concentration leads to lower resistivity and a higher plasma frequency.

The real (n) and imaginary (k) parts of the refractive index can be calculated from the dielectric function via:

ε(ω)^{1/2}=n(ω)+ik(ω)

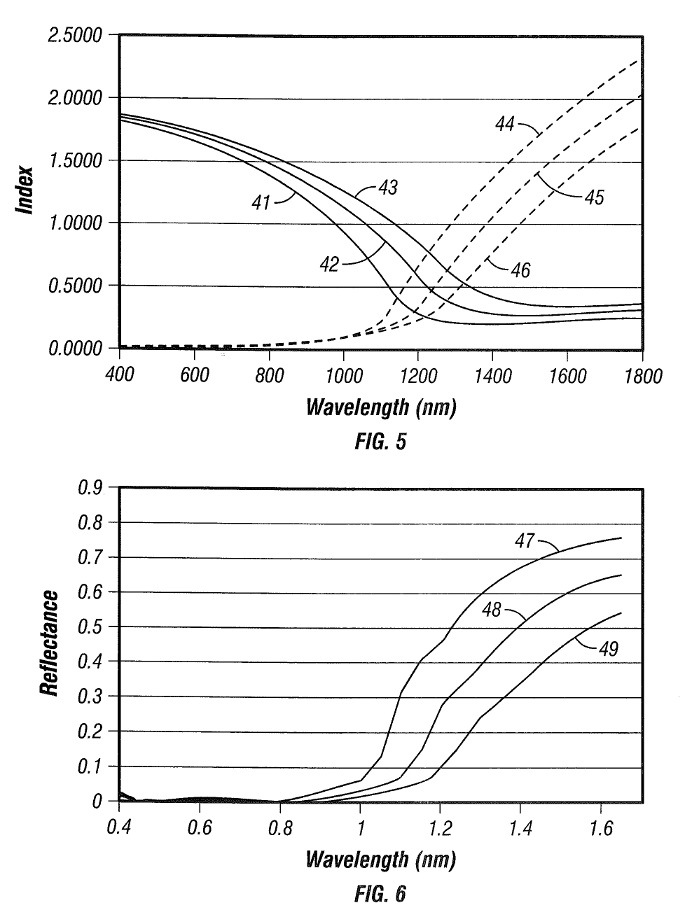

For sample resistivities of 129 μΩcm, 165 μΩcm, and 235 μΩcm, ε(ω) is computed, followed by computation of n(ω) for sample resistivities of 129 μΩcm (41), 165 μΩcm (42), and 235 μΩcm (43) and k(ω) for sample resistivities of 129 μΩcm (44), 165 μΩcm (45), and 235 μΩcm (46). The results are plotted in FIG. 5. The plasma frequency occurs at the wavelength where n=k, and marks the spectral location where high transmission transitions to high reflection. As ρ is reduced (higher conductivity), ωₚ moves to higher values (lower wavelengths).

The n and k curves may then be used to calculate the reflected (R) and transmitted (T) intensity, as functions of both wavelength and angle of incidence, of the glass/ITO/glass structure depicted in FIG. 4 as follows:

R=[(r₁+r₀e^{(-2iφ)}/(1+r₁r₀e^{(-2iφ)})]²

T=[(t₁t₀e^{(-1φ)})/(1+r₁r₀e^{(-2iφ)})]² ,

where r₁, r₀, t₁, and t₀ are complex terms given by the Fresnel equations, which describe the reflection and transmission of electromagnetic waves at an interface. The following gives terms for s-type and p-type polarization at the first ITO surface. For this geometry, terms for the second ITO surface are written by transposing θ and θ′.

$${r}_{1 s} = - sin ( θ - {θ}^{′} ) / sin ( θ + {θ}^{′} )$$

$${r}_{1 p} = - tan ( θ - {θ}^{′} ) / tan ( θ + {θ}^{′} )$$

$${t}_{1 s} = 2 cos ( θ ) sin ( {θ}^{′} ) / sin ( θ + {θ}^{′} )$$

$${t}_{1 p} = 2 cos ( θ ) sin ( {θ}^{′} ) / sin ( θ + {θ}^{′} ) cos ( θ - {θ}^{′} )$$

P-polarized light is linearly polarized light having an electric field vector that lies in a plane formed by the axis of light propagation and the line normal to a sample surface. S-polarized light is linearly polarized light that runs perpendicularly to this plane. The complex (including loss) phase factor φ is given by φ=(2π/λ)(n+ik)d cos(θ′), where λ is the wavelength and d is the ITO layer thickness. The angles θ and θ′ are related by Snell's equation: n_{glass} sin(θ)=(n+ik) sin(θ′), where n_{glass} is the real refractive index of the cube surrounding the ITO layer.

To perform these calculations, the angle of incidence θ, which is related to the external ray angles in FIG. 4 by θ=45±a sin[sin(θₑₓₜ)/n_{glass}] is selected. The external angles depend on the lens design and range from zero to about 16 degrees. This causes the angle of incidence θ to range from about 34 to 55 degrees. Snell's law is then used to translate θ into θ′, and θ′ is used to determine the interfacial reflectance and transmittance factors for a given polarization. These factors are finally used to calculate R and T for each polarization. Preservation of the phase of each complex quantity in these computations is necessary—even the transmitted amplitudes are complex for absorbing thin films. In addition, these calculations assume that the n+ik of the ITO is not a function of depth within the layer.

FIG. 6 shows modeled reflectance for the resistivities of 129 μΩcm (47), 165 μΩcm (48), and 235 μΩcm (49), and for an ITO thickness of 0.3 microns. The plots represent R averaged over the two polarization states for an angle of incidence of 34 degrees. Lower resistivity leads to higher near infrared reflectance, and a sharper spectral transition from low to high reflectance.

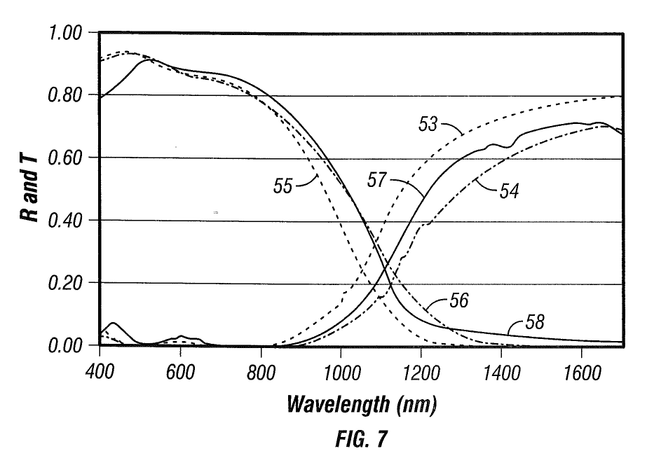

As shown in FIG. 7, the modeled R curves for resistivities of 129 μΩcm (53) and 165 μΩcm (54) and the modeled T curves for resistivities of 129 μΩcm (55) and 165 μΩcm (56) bracket the desired beam splitter performance—i.e., high reflectance at wavelengths above 1200 nm and high transmittance at wavelengths below 900 nm. As shown in FIG. 7, resistivity of approximately 155 μΩcm produces an R curve (57) and T curve (58) intersecting to divide the wavelength field between the VIS/NIR range and the NIR range.

In the preferred embodiment, the wavelength-selective material 24, the first transparent triangular prism 26, the second transparent triangular prism 27, and the reflector 28 are attached to the outside of a single hermetically-sealed housing containing the photodetectors 21 and 22.

The terms and expressions which have been employed in the foregoing specification are used therein as terms of description and not of limitation, and there is no intention, in the use of such terms and expressions, of excluding equivalents of the features shown and described or portions thereof.

I claim:

1. An apparatus for bifurcating a light beam, said light beam comprising a visible/near infrared light beam in the 400-900 nm band and a near-infrared light beam in the 1200-1700 nm band, between light in the 400-900 nm band and light in the 1200-1700 nm band comprising:
a) a first transparent triangular prism;
b) a second transparent triangular prism;
c) a light-splitting material;
1) said light-splitting material exhibiting high transmittance in the 400-900 nm band and high reflectance in the 1200-1700 nm band;
2) said light-splitting material having a surface;
d) the optical path length of said visible/near infrared light beam through said first transparent triangular prism and said light-splitting material and said second transparent triangular prism being equal to the optical path length of said near infrared light beam through said first transparent triangular prism to the surface of said light-splitting material and from the surface of said light-splitting material through said first transparent triangular prism.

2. The apparatus for bifurcating a light beam of claim 1, wherein:
said light-splitting material comprises indium tin oxide having a resistivity between 129 μΩcm and 165 μΩcm.

3. The apparatus for bifurcating a light beam of claim 2, wherein:
said visible/near infrared light beam exits said second transparent triangular prism parallel to the direction at which said visible/near infrared light beam enters said first transparent triangular prism.

4. The apparatus for bifurcating a light beam of claim 3, wherein:
said near infrared light beam exits said first transparent triangular prism at a right angle to the direction at which said near infrared light beam enters said first transparent triangular prism.

5. The apparatus for bifurcating a light beam of claim 4 further comprising:
a reflector proximate first transparent triangular prism positioned to reflect said near infrared light beam.

6. The apparatus for bifurcating a light beam of claim 5 wherein:
said reflector proximate first transparent triangular prism positioned to reflect said near infrared light beam in a direction parallel to the direction at which said near infrared light beam entered said first transparent triangular prism.

7. The apparatus for bifurcating a light beam of claim 6 wherein:
a) said first transparent triangular prism is composed of glass; and
b) said second transparent triangular prism is composed of glass.

8. The apparatus for bifurcating a light beam of claim 1, wherein:
said light-splitting material comprises indium tin oxide having a resistivity between 150 μΩcm and 160 μΩcm.

9. The apparatus for bifurcating a light beam of claim 2, wherein said dielectric behavior in the 400-900 nm band is characterized by transmittance of at least 60% of impinging light in the 400-900 nm band, and wherein said metallic behavior in the 1200-1700 nm band is characterized by reflectance of at least 50% of impinging light in the 1200-1700 nm band.

10. An apparatus for imaging product in a sorting machine in two light wavelength spectrums, said apparatus including:
a) a light-beam splitter for bifurcating a light beam, said light beam comprising a visible/near infrared light beam in the 400-900 nm band and a near-infrared light beam in the 1200-1700 nm band, between light in the 400-900 nm band and light in the 1200-1700 nm band comprising:
1) a first transparent triangular prism;
2) a second transparent triangular prism;
3) a light-splitting material,
A) said light-splitting material exhibiting high transmittance in the 400-900 nm band and high reflectance in the 1200-1700 nm band,
B) said light-splitting material having a surface;
4) the optical path length of said visible/near infrared light beam through said first transparent triangular prism and said light-splitting material and said second transparent triangular prism being equal to the optical path length of said near infrared light beam through said first transparent triangular prism to the surface of said light-splitting material and from the surface of said light-splitting material through said first transparent triangular prism.
b. a first photodetector;
c. a second photodetector;

11. The apparatus for imaging product in a sorting machine in two light wavelength spectrums of claim 10, wherein:
said light-splitting material comprises indium tin oxide.

12. The apparatus for imaging product in a sorting machine in two light wavelength spectrums of claim 11, wherein:
said visible/near infrared light beam exits said second transparent triangular prism in a direction parallel to the direction at which said visible/near infrared light beam enters said first transparent triangular prism.

13. The apparatus for imaging product in a sorting machine in two light wavelength spectrums of claim 12, wherein:
said near infrared light beam exits said first transparent triangular prism at a right angle to the direction at which said near infrared light beam enters said first transparent triangular prism.

14. The apparatus for imaging product in a sorting machine in two light wavelength spectrums of claim 13 further comprising:
a reflector proximate first transparent triangular prism positioned to reflect said near infrared light beam.

15. The apparatus for imaging product in a sorting machine in two light wavelength spectrums of claim 14 wherein:
said reflector proximate first transparent triangular prism positioned to reflect said near infrared light beam parallel to the direction at which said near infrared light beam entered said first transparent triangular prism.

16. The apparatus for imaging product in a sorting machine in two light wavelength spectrums of claim 15 wherein:
a) said first transparent triangular prism is composed of glass; and
b) said second transparent triangular prism is composed of glass.

17. The apparatus for imaging product in a sorting machine in two light wavelength spectrums of claim 16 wherein:
a) said visible/near infrared light beam impinges on said first photodetector after exiting said second triangular prism;
b) said near infrared light beam impinges on said second photodetector after reflecting from said reflector; and
c) said visible/near infrared light beam after exiting said second triangular prism and said near infrared light beam after reflecting from said reflector are parallel.

18. The apparatus for imaging product in a sorting machine in two light wavelength spectrums of claim 17, wherein:
said indium tin oxide having a resistivity between 129 μΩcm and 165 μΩcm.

19. The apparatus for imaging product in a sorting machine in two light wavelength spectrums of claim 17, wherein:
said indium tin oxide having a resistivity between 150 μΩcm and 160 μΩcm.

20. The apparatus for bifurcating a light beam of claim 2, wherein said dielectric behavior dielectric behavior in the 400-900 nm band is characterized by transmittance of at least 60% of impinging light in the 400-900 nm band, and wherein said metallic behavior in the 1200-1700 nm band is characterized by reflectance of at least 50% of impinging light in the 1200-1700 nm band.
